(19) United States
(12) Patent Application Publication
(10) Pub. No.: US 2023/0091482 A1
(43) Pub. Date: Mar. 23, 2023

(54) METHOD AND APPARATUS FOR APPLYING LIGHT TO CURE ADHESIVES

(71) Applicant: CORNING INCORPORATED, CORNING, NY (US)

(72) Inventors: David Richard Bonin, Pittsford, NY (US); Joshua Monroe Cobb, Victor, NY (US)

(21) Appl. No.: 17/945,506

(22) Filed: Sep. 15, 2022

Related U.S. Application Data
(60) Provisional application No. 63/247,364, filed on Sep. 23, 2021.

(51) Int. Cl. C09J 11/02

(52) U.S. Cl. CPC C09J 11/02; C09J 2301/416; C09J 2400/143

(57) ABSTRACT

Methods, systems, devices, and apparatuses are described. Light output by a light source may be transformed into an annular shape (e.g., a spatial distribution of the light may be modified to have an annular shape) to cure an adhesive material having a similar annular shape. For example, a system may include a light source emitting light (e.g., ultraviolet (UV) light) having an angular distribution and a spatial distribution. An optical system may modify a shape of the spatial distribution into an annular shape, and the light having the annular shape may be focused on an adhesive material to cure the adhesive material. In some examples, the adhesive material may be positioned between an optical element and a structural component, and the focused light in the annular shape may cure the adhesive material while simultaneously avoiding one or more other optical components or structures.

This application claims the benefit of priority to U.S. Provisional Patent Application Ser. No. 63/247,364 filed on Sep. 23, 2021, the content of which is relied upon and incorporated herein by reference in its entirety.

### FIELD OF TECHNOLOGY

The present disclosure relates generally to curing adhesive materials, and more specifically to a method and apparatus for applying light to cure adhesives.

### BACKGROUND

Optical systems may have various applications in research, medical procedures, imaging, and fabrication and microfabrication processes, such as photolithography, among other examples. In such systems, one or more optical components (e.g., lenses, mirrors, prisms) may be secured to structural components of the system using, for example, an adhesive that bonds an optical component to the structural component. As an example, an adhesive material may be applied between a lens and a mechanical housing, where the adhesive material may be cured to secure the lens relative to the mechanical structure (e.g., through crystallization of the adhesive material). In some cases, however, a location of the lens, a shape of the mechanical structure, a position of one or more other components in the optical system, other factors, or any combination thereof, may present challenges to curing the adhesive material.

### SUMMARY

The methods, apparatus, and devices of this disclosure each have several new and innovative aspects. This summary provides some examples of these new and innovative aspects, but the disclosure may include new and innovative aspects not included in this summary.

The described techniques relate to improved methods, systems, devices, and apparatuses that support applying light to cure adhesives. In particular, light from a light source may be transformed into a ring (e.g., a spatial distribution of the light may be modified to have an annular shape) to cure an adhesive material having a similar shape or a complementary shape. In such cases, one or more optical components may be used to modify the light from the light source, and the one or more optical components may have various configurations for efficiently and effectively curing the adhesive material. For example, a system for curing adhesives may include a light source (e.g., an ultraviolet (UV) light source) emitting light having an angular distribution and a spatial distribution, and the system may in some examples include an optical system to modify a shape of the spatial distribution into an annular shape (e.g., while a shape of the angular distribution may remain unchanged). The components of the optical system may include, for example, a collimating lens, an axicon, and one or more lenses, among other components. An output of the optical system may be focused on an adhesive material (e.g., having photo-initiators), and the output of the optical system having the annular shape may be incident on the adhesive material to cure the adhesive material. In some cases, the adhesive material may be positioned between an optical element and a structural component, and curing the adhesive using the focused light having the annular shape may provide for faster curing times compared to other different techniques, thereby bonding the optical element to the structural component in a relatively short duration.

By modifying the shape of the spatial distribution of the light emitted by the light source, energy from the light source may be more efficiently shaped and focused in curing the adhesive. The modified shape of the light may also avoid other components, structures, or both, positioned between the light source and the adhesive. Such techniques may accordingly reduce or eliminate light from the light source being incident on components, thereby preventing those components from unnecessarily heating (e.g., by irradiation from UV light) and preventing issues (e.g., such as misalignment). Put a different way, the system may transform an etendue of the light source to match an etendue of the adhesive material, thereby increasing the efficiency of curing the adhesive material and resulting in relatively fast curing times and reduced cost.

A system is described. The system may include a light source configured to generate an output having a first spatial distribution. In some examples, the system may include an optical system configured to receive the output of the light source and modify a shape of the first spatial distribution to produce a second spatial distribution having an annular shape that is different than the shape of the first spatial distribution, where the optical system may be configured to transmit an output having the annular shape that is incident on an adhesive material to cure the adhesive material.

A method is described. The method may include generating light having a first spatial distribution using a light source and altering the first spatial distribution into a second spatial distribution having an annular shape using at least a first optic and a second optic, the annular shape being different than a shape of the first spatial distribution, where the first optic may direct the light to the second optic and the second optic may output the light having the second spatial distribution. In some examples, the method may include curing, using the light output from the second optic having the second spatial distribution, an adhesive that may be in contact with a structure supporting an optical element.

An apparatus is described. The apparatus may include a light source configured to transmit light having a first angular distribution and a first spatial distribution, a collimating lens configured to receive the light transmitted by the light source, and an axicon configured to receive and modify light output by the collimating lens into light having a second angular distribution and a second spatial distribution, where a shape of the second spatial distribution includes an annular shape different than a shape of the first spatial distribution, and where the collimating lens may be positioned between the light source and the axicon. In some examples, the apparatus may include a lens configured to focus the light having the second spatial distribution output by the axicon onto an adhesive material positioned between a structure and an optical element, where the axicon may be positioned between the collimating lens and the lens. In some examples, the apparatus may include the optical element supported by the structure based on the adhesive material that may be positioned between the optical element and the structure, where the output of the lens may be configured to cure the adhesive material using the focused light from the lens.

### BRIEF DESCRIPTION OF THE DRAWINGS

FIG. 1 illustrates an example of a system that supports a method and apparatus for applying light to cure adhesives in accordance with aspects of the present disclosure.

FIG. 2 illustrates an example of a system that supports a method and apparatus for applying light to cure adhesives in accordance with aspects of the present disclosure.

FIGS. 3A and 3B illustrate an example of a system that supports a method and apparatus for applying light to cure adhesives in accordance with aspects of the present disclosure.

FIG. 4 illustrates an example of a system that supports a method and apparatus for applying light to cure adhesives in accordance with aspects of the present disclosure.

FIG. 5 illustrates an example of an irradiance distribution that supports a method and apparatus for applying light to cure adhesives in accordance with aspects of the present disclosure.

FIGS. 6 and 7 show flow charts that support a method and apparatus for applying light to cure adhesives in accordance with aspects of the present disclosure.

### DETAILED DESCRIPTION

Optical systems may include various optical components, such as light sources (e.g., lasers, light-emitting diodes (LEDs)) and optical elements (e.g., transmissive elements, refractive elements, lenses, windows, prisms, beam splitters), as well as other structural components, mechanical components, or the like (e.g., for supporting, holding, and/or positioning the optical elements). An optical system may thus include one or more optics that are in contact with or adhered to a structural component of the system, for example, using an adhesive material that bonds the optic to the structural component. In such cases, an optical element may be adhered to a structural component with some degree of precision to satisfy various parameters and in accordance with the system's design and operation (e.g., to provide alignment with one or more other components of the system, to account for a focal length of a lens element based on a configuration of the system). Thus, after applying an adhesive and positioning the optical element, the adhesive may be cured to secure the optical element in place, where the adhesive may be cured through one or more curing processes. For instance, the adhesive may be a material that is cured via exposure to light (e.g., ultraviolet (UV) light), heat, chemicals, or the like. In some aspects, the adhesive material may include UV photoinitiators that enable the adhesive material to be cured when exposed to UV radiation (e.g., UV light from a light source).

To cure the adhesive that is positioned between the optical element and the structural component, light may be used to flood a volume including the optical element and the adhesive. For instance, multiple light sources (e.g., multiple LEDs) may be used to expose the adhesive material to UV light. Such techniques, however, may result in relatively small quantities of light reaching the adhesive material (e.g., as compared to a total output of the light source). This may extend the amount of time to cure the adhesive, while also increasing the amount of time other components are unnecessarily exposed to UV light. Specifically, the adhesive used to bond the structural component and the optical element may have an annular shape (e.g., surrounding an annular optical element) with a relatively small area exposed for accepting incident light. Further, some portions of the adhesive may be at least partially blocked from exposure to UV light by the structural component, the optical element itself, some other component(s), or any combination thereof. Thus, flooding a volume with UV light may result in exposing multiple components to the UV light for relatively long periods of time while curing the adhesive, and the UV light incident on these other components may generate excessive heat, among other drawbacks. In some cases, this heat may cause one or more optical components and/or structural components to move (e.g., through thermal expansion), potentially resulting in misalignment and other undesirable issues.

As described herein, systems and techniques may enable the transformation of light from a light source (e.g., an LED or other light source) into a uniform ring that cures an adhesive material. For example, the described systems and techniques may enable efficient curing of adhesives by approximately matching an etendue of the light source to an etendue of the adhesive, such as an adhesive that bonds a lens element to a structural component. In such cases, the adhesive may be curable by light (e.g., UV light), and one or more optical components may be configured to modify a shape of a spatial distribution of light emitted by the light source into an annular shape. Put another way, the light from the light source may be modified to match the spatial and angular acceptance of the adhesive material. By aligning the output of the one or more optical components (e.g., having the annular shape) with the adhesive (e.g., having a similar annular shape), the adhesive may be cured relatively quickly with UV light. Such techniques may be particularly advantageous when the optical element is enclosed within a mechanical structure and in cases where it may be difficult to get light to the adhesive (without otherwise flooding the volume with light).

In some aspects, an optical system for modifying light emitted by the light source may include a collimating lens and an axicon (e.g., a refractive axicon or a reflective axicon), where the collimating lens may direct an output of the light source to the axicon. The axicon may diverge the light into the annular shape. The optical system may include one or more lenses used to focus the light from the axicon on the adhesive material. Further, another lens (e.g., positioned between the axicon and a focusing lens) may be used to modify a diameter of the light that is incident on the adhesive material. Additionally or alternatively, the optical system may include a beamsplitter that is optically transmissive to the light from the light source and optically reflective to visible light. In such cases, the beamsplitter may be configured such that a camera may be used for capturing light from the adhesive material while it is being cured by the light in the annular shape, enabling monitoring of the curing process, among other advantages. In some other examples, the optical system may include a mask, a relay system, and a mirror, where at least one component of the light in the annular shape used to cure the adhesive may be formed by light that is partially transmitted through the mask, imaged via the relay system, and directed to the adhesive using the mirror (e.g., a fold mirror). In such examples, another component of the of the light in the annular shape used to cure the adhesive may be formed by a similar system including, for example, another collimating lens, another axicon, one or more focusing lenses, another mask, another relay system, and producing an output that is reflected by the mirror.

Aspects of the disclosure are initially described in the context of systems used to cure adhesive materials using light having an annular distribution. Aspects of the disclosure are further illustrated by and described with reference to irradiance distributions and flowcharts that relate to methods and apparatus for applying light to cure adhesives.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally or alternatively solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

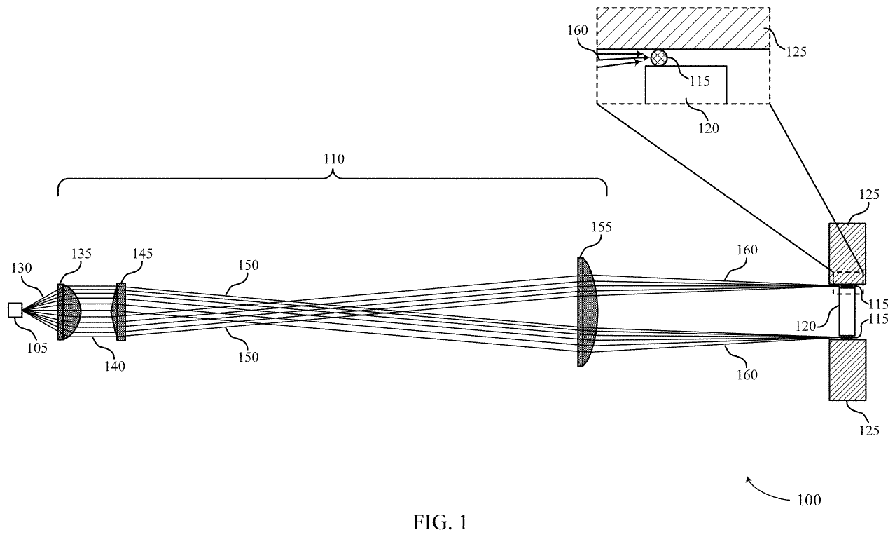

FIG. 1 illustrates an example of a system 100 that supports a method and apparatus for applying light to cure adhesives in accordance with aspects of the present disclosure. In some examples, the system 100 may support etendue transformation for curing adhesives. The system 100 may include various components, such as a light source 105 and an optical system 110. The optical system 110 may be configured to receive an output of the light source 105 and to modify a shape of the spatial distribution of the output of the light source 105. In such cases, the optical system 110 may produce an output having a second spatial distribution in an annular shape (e.g., different from the shape of the output of the light source 105). In any case, the light source 105 and the optical system 110 may be configured to cure an adhesive material 115 that is positioned between an optical element 120 and a structural component 125 (e.g., a mechanical housing).

For example, the optical element 120 (e.g., a lens, a mirror, a prism) may be a component of a system of optical elements (e.g., consisting of one or more optical elements, which may include lenses, mirrors, light sources, prisms, detectors, screens, dispersing components, filters, thin films, and the like). The optical element 120 may in some cases have a circular shape (e.g., a circular cylinder lens), and the optical element 120 may be bonded (e.g., adhered, held, attached) to a structural component 125 of the system of optical elements using the adhesive material 115. In such cases, the structural component 125 may be an example of a mechanical component or other type of component configured to support one or more optical elements (e.g., including optical element 120).

Based on an application of the system of optical elements (e.g., microscopy, imaging, photolithography, laser optics, medical application, among other example applications), the optical element 120 may be positioned and adhered to the structural component 125 based on some set of parameters (e.g., with some degree of precision) to ensure proper functionality of the system of optical elements. In such cases, the adhesive material 115 may be applied to the optical element 120 or the structural component 125, or both, and the optical element 120 may be positioned to adhere the optical element 120 to the structural component 125. In some examples, and as discussed herein, the optical element 120 may positioned using one or more other components of the system 100. After the optical element 120 is positioned, the adhesive material 115 located between the optical element 120 and the structural component 125 may be cured to hold the optical element 120 in place.

Curing the adhesive material 115 may refer to a process (e.g., a chemical process) by which the adhesive material 115 crystalizes, resulting in the adhesive material 115 achieving a relatively rigid structure and holding the optical element 120 in place (e.g., prohibiting movement of the optical element 120 with respect to, for example, the structural component 125). The adhesive material 115 may be cured through various curing processes, including exposure to radiation in the form of light, or heat, or both. For instance, the adhesive material 115 may include one or more photoinitiators that react (e.g., that produce a reactive species) when exposed to light and serve to cure the adhesive material 115. In some aspects, the adhesive material 115 may include UV photoinitiators reactive to UV light. The optical element 120 may thus be bonded in place (e.g., on the structural component 125) by the adhesive material 115 that is cured using UV light. In some cases, a portion of the adhesive material 115 that surrounds the optical element 120 may be referred to as a bond line or some other terminology.

The adhesive material 115 may be formed in an adhesive ring (e.g., in an annular shape), or another shape, at least partially surrounding the optical element 120. The adhesive material 115, however, may have a relatively small area exposed to the UV light during the curing process. For example, an exposed area of the adhesive material 115 (e.g., corresponding to a bond line) may include a relatively thin annular area that accepts a relatively narrow angular range as a valid path for the UV light. In some cases, the optical element 120 (or another component being adhered with the adhesive material 115) may not be optically transmissive to light having the same wavelength as the light source 105. For instance, the optical element 120 may not transmit UV light. Additionally or alternatively, one or more mechanical structures or structural components (e.g., including the structural component 125) may block the light used to cure the adhesive material 115. Further, the optical element 120 may be aligned and held into a position using, for example, a vacuum chuck while the UV light is incident upon the adhesive material 115 during a curing process.

As a result, it may be challenging to expose the adhesive material 115 to light during the curing process. In particular, because the structural component 125, other components, optical elements (e.g., including the optical element 120 itself), or any combination thereof, may block a path of the UV light, it may be difficult to effectively illuminate the bond line (e.g., the area of the adhesive material 115 that may be directly illuminated by the UV light). In addition, there may be relatively more power in a single light source than is incident on an exposed areas of the adhesive material 115. Challenges to curing the adhesive material may also be a result of the light source having a different shape and/or angular distribution to effectively illuminate the etendue of the adhesive material 115. In particular, the bond line of the adhesive material 115 may have an acceptance etendue which may collect a particular spatial distribution and a particular angular distribution that is different than a spatial distribution and angular distribution of the light source 105.

In some cases (such as with alternative techniques different from those described herein), the adhesive material 115 may be cured by attempting to flood a volume including the adhesive material 115 (as well as the optical element 120, the structural component 125, and/or one or more additional components) with UV light. For example, multiple light sources (e.g., LEDs, lasers, light guides that carry UV light from an external source, or the like) may be used to emit UV light to flood a volume and cure the adhesive material 115. Further, to account for the annular shape of the adhesive material 115, the multiple light sources may be placed in a ring configuration for curing the adhesive material 115 by flooding the volume including multiple components with light. Such techniques, however, may result in relatively little UV light being incident on the adhesive material 115. For example, less than one percent (1%) of the light from one or more light sources may be incident on the adhesive material 115, resulting in a relatively small percentage of the energy irradiating the adhesive material 115 for the curing process.

As a consequence, a majority of the energy from the light source(s) may be incident on components surrounding the adhesive material 115 that, in turn, may be heated by the UV light. This heat may cause movement of the optical element 120 (or other components) during the curing process. For example, thermal expansion caused by the absorption of UV radiation may cause the optical element 120 to move in one or more directions during the curing process. Such movement may alter the positioning, or alignment, or both, of the optical element 120, among other components, during the curing process, thereby impacting the effectiveness of the optical element 120 within the system of optical elements (e.g., due to misalignment). As an example, as one or more components (e.g., different from the adhesive material 115) are heated by UV light, movement between the optical element 120 and the structural component 125, or between the optical element 120 and one or more other optical elements (e.g., lenses, mirrors) may occur, pulling the respective components out of alignment. In some cases, light used for flooding the volume including the adhesive material 115 may be cycled on and off so that various components may have an opportunity to cool (e.g., through the relative reduction of heat generated by exposure to UV light). But such techniques may result in relatively longer curing times (e.g., because no curing occurs while the light is turned off). For instance, the curing time may last one hour or more. Such lengthy processing times may add to manufacturing costs and decrease production.

Aspects of the present disclosure provide for methods, systems, and apparatuses that redistribute the etendue of a light source into the etendue of the adhesive bond line so that relatively more power is directed to reach the bond line, while simultaneously using relatively fewer light sources 105. Such techniques and systems may also prevent or minimize other components in a system being irradiated by light and heating up, thereby avoiding unwanted movement and misalignment issues. Thus, the describes techniques and systems support the curing of adhesives, and more specifically to the curing of adhesives that bond optical elements 120 in place (e.g., on a mechanical element, such as the structural component 125). Here, the described systems and techniques may further support improvements in curing adhesives through the alignment of the optical system 110 that is used to cure the adhesive with light (e.g., UV light). For example, the light source 105 and the optical system 110 may be configured to efficiently cure the adhesive material 115 by focusing the energy of the light source 105 on the adhesive material 115 and achieving relatively quick curing times.

In some cases, the light source 105 may be an example of a component that generates light. For example, the light source 105 may be an LED configured to emit UV light. The light source 105 may be an example of another component that provides light to the system 100 (e.g., such as a component that directs light from an external source). In the system 100, the light source 105 may be selected based on one or more photoinitiators included in the adhesive material 115, where an output 130 of the light source 105 may be used to irradiate the adhesive material 115 for curing of the adhesive material 115. In some cases, the light source 105 may be configured to emit light having a different wavelength than UV light, such as visible light. The output 130 from the light source 105 may include light having a first angular distribution and a first spatial distribution.

The optical system 110 may include a first optic 135 and a second optic 145. The first optic 135 may be an example of a collimating lens, and the first optic 135 may be configured to receive the output 130 of the light source 105 and transmit an output 140 to the second optic 145. In some examples, the output 140 of the first optic 135 may be collimated (e.g., including rays of light that are approximately parallel to each other). In some other examples, the first optic 135 may be configured to virtually image the output 130 of the light source 105 and direct the virtual image to the second optic 145.

The second optic 145 may be an example of an axicon (e.g., a refractive axicon or a reflective axicon), and the second optic 145 may be configured to receive the output 140 from the first optic 135 (e.g., collimated light) and diverge the collimated light into a ring. More specifically, the second optic 145 may transmit light having a second angular distribution and a second spatial distribution, where the second spatial distribution may have an annular shape that is different than a shape of the first spatial distribution (e.g., corresponding to the output 130 of the light source 105). In such cases, while the output 150 of the second optic 145 may include light in the annular shape and having the second spatial distribution, a shape of the second angular distribution of the output 150 may be the same as a shape of the first angular distribution. Put another way, the second optic 145 may modify the light output by the light source 105 and received from the first optic 135 into the annular shape without modifying the angular distribution of the light emitted by the light source 105 (e.g., without modifying a shape of the angular distribution of the light from the light source 105). The output 150 of the second optic 145 may thus be ring-shaped and in some cases may be divergent (e.g., with an expanding diameter as light propagates away from the second optic 145).

The optical system 110 may include a third optic 155 (e.g., a lens, a mirror) configured to focus the output 150 of the second optic 145 on the adhesive material 115. Specifically, the third optic 155 may be positioned to receive the output 150 and to produce an output 160 that is in an annular shape and focused on the adhesive material 115. In some examples, the focused output 160 may be telecentric with relation to the optical element 120 (e.g., a central ray of the output 160 may be parallel to an axis of the optical element 120). By focusing the output 160 of the third optic 155, light in an annular shape (e.g., having a spatial distribution in an annular shape) may match an etendue of the adhesive material 115 during a curing process.

In some aspects, the third optic 155 may be optional in the optical system 110. That is, the third optic may be omitted, and the annular output 150 of the second optic 145 may be used to cure the adhesive material 115. In such cases, the output 150 of the second optic 145 may be incident on at least a portion of one or both of the optical element 120 or the structural component 125, but may still provide advantages over other techniques for curing the adhesive material 115 (such as flooding a volume with UV energy for some duration of time).

The system 100 may thus be configured to shape the light from light source 105 (e.g., into an annular shape, a ring shape, a circular shape, a disk shape, an ovular shape, or the like) to match an etendue (e.g., an acceptance etendue) of the adhesive material 115, which may have a similar shape. Accordingly, relatively more energy may be delivered into the bond line of the adhesive material 115 (e.g., as compared to placing multiple light sources for flooding an area with UV light). In addition, due to the use of a single light source 105 and/or the shaping of the light output by the light source 105, relatively less energy may be delivered to other components (e.g., the optical element 120, the structural component 125, other components) that are nearby the bond line of the adhesive material 115, thereby avoiding temperature increases in the area around or near the adhesive material 115. Such techniques may allow for the light source 105 to be continually on, thus reducing the time to cure the adhesive. Thus, the techniques and systems described herein may advantageously enable efficient curing of the adhesive material 115 relatively quickly while also minimizing or eliminating the issues of misalignment caused by unnecessarily heated components.

It is noted that, although the examples provided herein are described with reference to UV light and a UV-curable adhesive material 115, the system 100 may be configured with a light source 105 that generates light having one or more other wavelengths (e.g., non-UV light) to cure an adhesive material 115. As such, the examples of UV light described herein shall not be considered limiting to the scope covered by the claims or the disclosure.

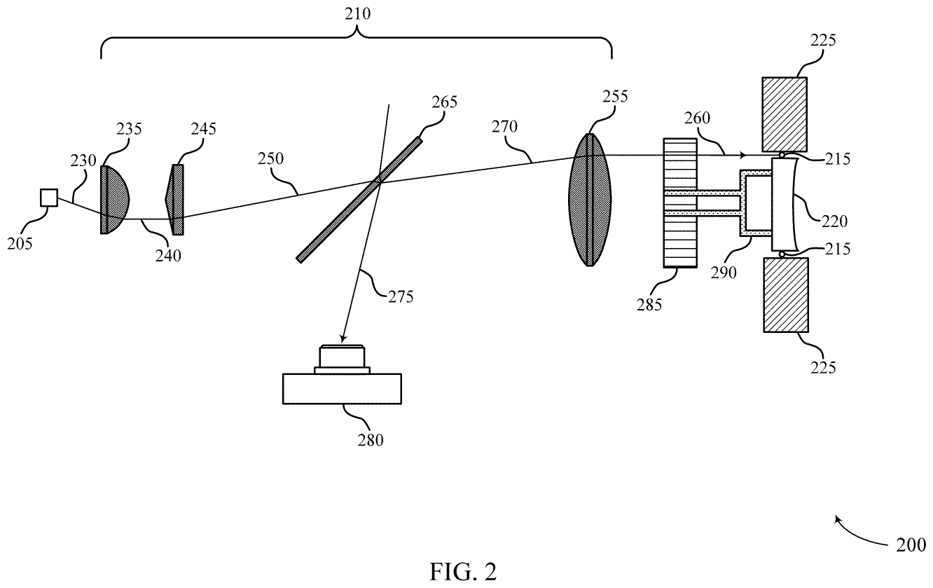

FIG. 2 illustrates an example of a system 200 that supports a method and apparatus for applying light to cure adhesives in accordance with aspects of the present disclosure. In some examples, the system 200 may support etendue transformation for curing adhesives. The system 200 may be an example of the system 100 described with reference to FIG. 1. For instance, the system 200 may include various components, such as a light source 205 and an optical system 210. The optical system 210 may be configured to receive an output of the light source 205 and to modify a shape of the spatial distribution of the output of the light source 205. In such cases, the optical system 210 may produce an output having a second spatial distribution in an annular shape (e.g., different from the shape of the output of the light source 205). The light source 205 and the optical system 210 may thus be configured to cure an adhesive material 215 that is positioned between an optical element 220 (e.g., a lens, a mirror) and a structural component 225 (e.g., a mechanical housing, a structure).

The light source 205 may be an example of the light source 105 described with reference to FIG. 1. For example, the light source 205 may be an example of a component that generates light, such as an LED configured to emit UV light. Additionally or alternatively, the light source 205 may be an example of another component that provides light to the system 200 (e.g., such as a component that directs light from an external source). In the system 200, an output 230 of the light source 205 may be used to irradiate the adhesive material 215 for curing of the adhesive material 215. In some cases, the light source 205 may be configured to emit light having a different wavelength than UV light, such as visible light. The output 230 from the light source 205 may include light having a first angular distribution and a first spatial distribution. It is noted that the output 230 from the light source 205 (as well as the respective outputs of other components of the system 200) is depicted as a single ray representing some portion of light that propagates through the system 200. A person having ordinary skill in the art, however, would understand that the output 230 may include multiple rays from the light source 305, and the single ray illustrated as propagating through the system 200 shall not be considered as limiting. That is, the output 230 of the light source 205 (as well as the output of other components of the system 200) may be similar to the outputs described with reference to FIG. 1 including multiple rays of light.

In some examples, the optical system 210 may include a first optic 235 and a second optic 245. The first optic 235 may be an example of a collimating lens that may be configured to receive the output 230 of the light source 205 and transmit an output 240 to the second optic 245. In some examples, the output 240 of the first optic 235 may be collimated (e.g., including rays of light that are approximately parallel to each other). In some other examples, the first optic 235 may be configured to virtually image the output 230 of the light source 205 and direct the virtual image to the second optic 245.

The second optic 245 may be an example of an axicon, and the second optic 245 may be configured to receive the output 240 from the first optic 235 (e.g., collimated light) and diverge the collimated light into an annular shape (e.g., a ring). More specifically, the second optic 245 may transmit light (e.g., the output 250) having a second angular distribution and a second spatial distribution, where the second spatial distribution may have the annular shape that is different than a shape of the first spatial distribution (e.g., corresponding to the output 230 of the light source 205). In such cases, while the output 250 of the second optic 245 may include light in the annular shape and having the second spatial distribution, a shape of the second angular distribution of the output 250 may be the same as a shape of the first angular distribution. Here, the second optic 245 may modify the light output by the light source 205 and received from the first optic 235 into the annular shape without modifying a shape of the angular distribution of the light emitted by the light source 205. The output 250 of the second optic 245 may thus be ring-shaped and in some cases may be divergent (e.g., with an expanding diameter as light propagates away from the second optic 245).

The optical system 210 may include a third optic 255 configured to focus light in an annular shape on the adhesive material 215. In some examples, the third optic 255 may be an example of a lens or a mirror. The third optic 255 may be positioned to produce an output 260 that is in an annular shape and focused on the adhesive material 215. In some examples, the focused output 260 may be telecentric with relation to the third optic 255 (e.g., a central ray of the output 260 may be parallel to an axis of the optical third optic 255). By focusing the output 260 of the third optic 255, light in an annular shape (e.g., having a spatial distribution in an annular shape) may match an etendue of the adhesive material 215 during a curing process.

In some examples, the optical system 210 may include a beamsplitter 265 that is positioned between the second optic 245 and the third optic 255. In such cases, the output 250 of the second optic 245 may pass through the beamsplitter 265 and may be directed to the third optic 255. As such, the third optic 255 may be configured to receive an output 270 of the beamsplitter 265. In addition, the beamsplitter 265 may be configured to direct light 275 from the adhesive material 115 to an imaging component 280 (e.g., a camera). As such, the imaging component 280 may be configured to view a bond line of the adhesive material 215, and the imaging component 280 may create an image of the adhesive material 215, at least a portion of the optical element 220 (e.g., an edge of the optical element 220), and/or at least a portion of the structural component 225 (e.g., during the process to cure the adhesive material 215). In some cases, the beamsplitter 265 may be optically transmissive to light emitted by the light source 205 (e.g., UV light) while being optically reflective to visible light.

As described herein, the system 200 may support techniques for diverting light in the annular shape to avoid one or more components positioned between the light source 205 and the adhesive material 215, thereby enabling efficient curing of the adhesive material 215 by the light source 205. As an illustrative example, the system 200 may include a window 285 and structure such as a chuck 290 (e.g., a vacuum chuck). The chuck 290 may be configured to hold the optical element 220 in a particular position while curing the adhesive material 215 (e.g., by vacuum). For instance, the chuck 290 may pass through an opening of the window 285 (e.g., a hole in the center of window 285), and vacuum may be drawn, for example, from a volume between the third optic 255 and the window 285.

Based on the configuration of the optical system 210 (e.g., including a configuration of the first optic 235, the second optic 245, and the third optic 255), light from the light source 205 may be modified into an annular shape and used to cure the adhesive material 215 while avoiding one or more components (e.g., the chuck 290) that may otherwise block the light from the light source 205. Specifically, the output 260 of the third optic 255 (e.g., a ring of UV light) may pass around the chuck 290 and may illuminate the bond line of the adhesive material 215. It is understood that the system 200 may be configured in ways that enable the light from the light source 205 to avoid other components in addition to, or alternative to, the chuck 290.

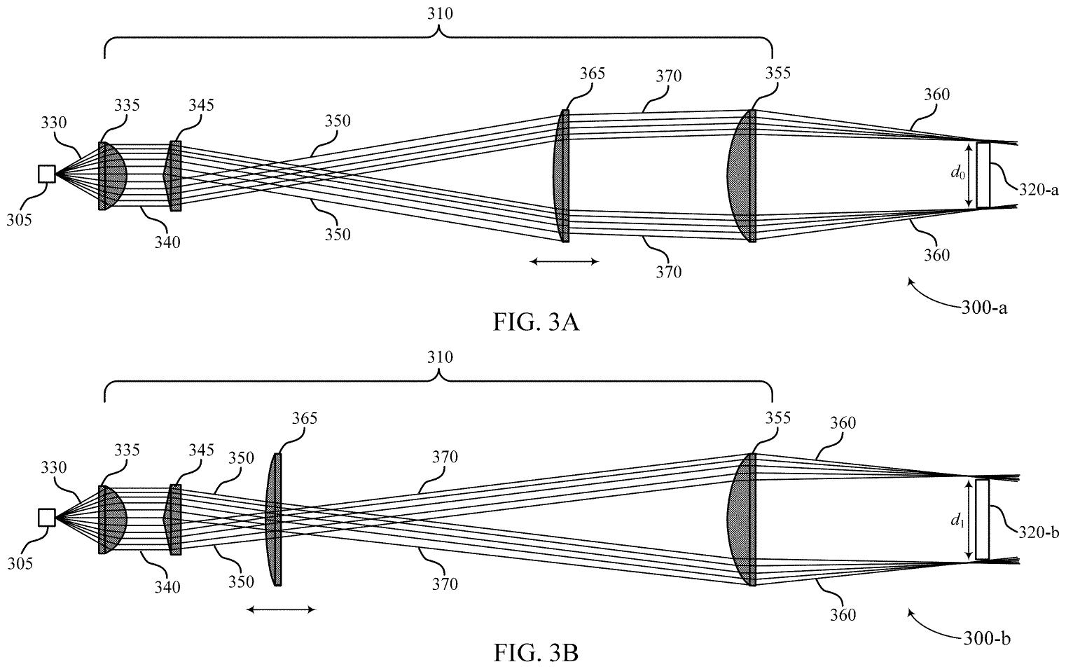

FIGS. 3A and 3B illustrate an example of a system 300 (e.g., system 300-a and system 300-b) that supports a method and apparatus for applying light to cure adhesives in accordance with aspects of the present disclosure. In some examples, the system 300 may support etendue transformation for curing adhesives. The system 300 may be an example of the system 100 described with reference to FIG. 1 and/or the system 200 described with reference to FIG. 2. For instance, the system 300 may include various components, such as a light source 305 and an optical system 310. The optical system 310 may be configured to receive an output of the light source 305 and to modify a shape of the spatial distribution of the output of the light source 305. In such cases, the optical system 310 may produce an output having a second spatial distribution in an annular shape (e.g., different from the shape of the output of the light source 305). The light source 305 and the optical system 310 may thus be configured to cure an adhesive material that is positioned between an optical element 320-a or optical element 320-b (e.g., a lens, a mirror) and a structural component (such as a structural component 125 or structural component 225 illustrated in FIGS. 1 and 2, respectively).

The light source 305 may be an example of the light source 105 described with reference to FIG. 1 or the light source 205 described with reference to FIG. 2. For example, the light source 305 may be an example of a component that generates light, such as an LED configured to emit UV light. Additionally or alternatively, the light source 305 may be an example of another component that provides light to the system 300 (e.g., such as a component that directs light from an external source). In the system 300, an output 330 of the light source 305 may be used to irradiate the adhesive material for curing of the adhesive material. In some cases, the light source 305 may be configured to emit light having a different wavelength than UV light, such as visible light. The output 330 from the light source 305 may include light having a first angular distribution and a first spatial distribution.

In some examples, the optical system 310 may include a first optic 335 and a second optic 345. The first optic 335 may be an example of a collimating lens, and the first optic 335 may be configured to receive the output 330 of the light source 305 and transmit an output 340 to the second optic 345. In some examples, the output 340 of the first optic 335 may be collimated (e.g., including rays of light that are approximately parallel to each other). In some other examples, the first optic 335 may be configured to virtually image the output 330 of the light source 305 and direct the virtual image to the second optic 345.

The second optic 345 may be an example of an axicon, and the second optic 345 may be configured to receive the output 340 from the first optic 335 (e.g., collimated light) and diverge the collimated light into an annular shape (e.g., a ring). More specifically, the second optic 345 may transmit light (e.g., the output 350) having a second angular distribution and a second spatial distribution, where the second spatial distribution may have the annular shape that is different than a shape of the first spatial distribution (e.g., corresponding to the output 330 of the light source 305). In such cases, while the output 350 of the second optic 345 may include light in the annular shape and having the second spatial distribution, a shape of the second angular distribution of the output 350 may be the same as a shape of the first angular distribution. Here, the second optic 345 may modify the light output by the light source 305 and received from the first optic 335 into the annular shape without modifying a shape of the angular distribution of the light emitted by the light source 305. The output 350 of the second optic 345 may thus be ring-shaped and in some cases may be divergent (e.g., with an expanding diameter as light propagates away from the second optic 345).

The optical system 310 may include a third optic 355 (e.g., a lens, a mirror) configured to focus light in an annular shape on the adhesive material. Specifically, the third optic 355 may be positioned to produce an output 360 that is in an annular shape and focused on an adhesive material. By focusing the output 360 of the third optic 355, light in an annular shape (e.g., having a spatial distribution in an annular shape) may match an etendue of the adhesive material during a curing process.

In some cases, bond lines for different optical elements (e.g., optical element 320-a, optical element 320-b) may be a different diameter (e.g., based on a diameter of the optical element). As such, system 300 may support changes to an illumination ring diameter for optical elements having different sizes, and an additional optic (e.g., a lens) may be used in conjunction with the third optic 355 to focus the ring (e.g., output 360) on a bond line of an adhesive material. For example, the optical system 310 may include a fourth optic 365 configured to modify a diameter of the output 360 of the third optic 355. Specifically, and as illustrated by system 300-a of FIG. 3A, the fourth optic 365 may be positioned between the third optic 355 and the second optic 345. As such, the fourth optic 365 may be configured to receive the output 350 of the second optic 345, and transmit an output 370 to the third optic 355. Here, the fourth optic 365 may be adjusted (e.g., repositioned) to change the magnification of the ring used to cure the adhesive material, thus allowing a same illuminator (e.g., light source 305) to be used for curing multiple adhesive diameters. For example, the fourth optic 365 may be movable or configurable to be located at different distances from the third optic 355. Based, at least in part, on a position of the fourth optic 365 with respect to the third optic 355, the third optic 355 and the fourth optic 365 may function to adjust (e.g., change, modify) a diameter of the light having the annular shape that is output by the optical system 310 and incident on the adhesive material. Such modification may enable the use of the system 300-a, 300-b for dynamically curing adhesive materials that bond optical elements having different sizes (e.g., optical element 320-a having a different size than optical element 320-b), for example, without having to replace one or more components of the optical system 310.

As an illustrative example, in a first configuration illustrated by the system 300-a, the third optic 355 and a position of the fourth optic 365 may result in the output 360 of the third optic 355 (e.g., light having the second spatial distribution in the annular shape) having a first diameter, do. In a second configuration illustrated by the system 300-b, the third optic 355 and a different position of the fourth optic 365 may result in the output 360 of the third optic 355 having a second diameter, d₁, different than the first diameter. For example, the second diameter may be greater than the first diameter (e.g., d₁>d₀) based on the position of the fourth optic 365 with respect to the third optic 355. As such, an adhesive material applied to a different optical element (e.g., optical element 320-b) with a size corresponding to the second diameter may be cured using the configuration illustrated by the system 300-b.

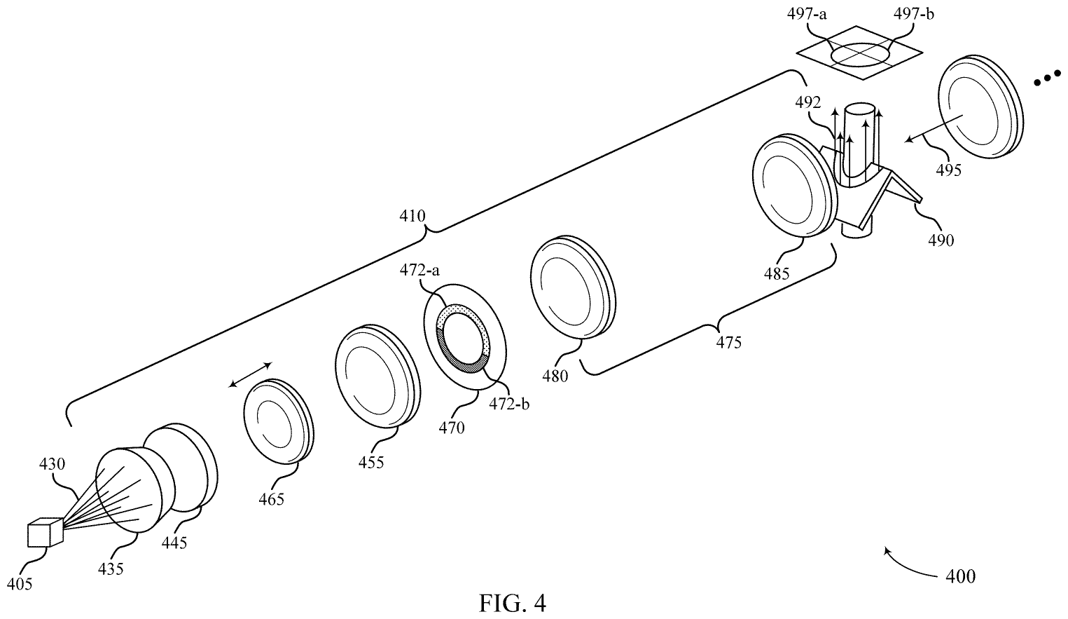

FIG. 4 illustrates an example of a system 400 that supports a method and apparatus for applying light to cure adhesives in accordance with aspects of the present disclosure. In some examples, the system 400 may support etendue transformation for curing adhesives. The system 400 may be an example of the system 100, system 200, or system 300 described with reference to FIGS. 1-3. For instance, the system 400 may include various components, such as a light source 405 and an optical system 410. The optical system 410 may be configured to receive an output of the light source 405 and to modify a shape of the spatial distribution of the output of the light source 405. In such cases, the optical system 410 may produce an output having a second spatial distribution in an annular shape (e.g., different from the shape of the output of the light source 405). The light source 405 and the optical system 410 may thus be configured to cure an adhesive material that is positioned between an optical element (e.g., a lens, a mirror, a prism) and a structural component (such as a structural component 125 or structural component 225 illustrated in FIGS. 1 and 2, respectively).

The light source 405 may be an example of the light source 105 described with reference to FIG. 1, the light source 205 described with reference to FIG. 2, or the light source 305 described with reference to FIGS. 3A and 3B. For example, the light source 405 may be an example of a component that generates light, such as an LED configured to emit UV light. Additionally or alternatively, the light source 405 may be an example of another component that provides light to the system 400. In the system 400, an output 430 of the light source 405 may be used to irradiate the adhesive material, for example, to cure the adhesive material. The output 430 from the light source 405 may include light having a first angular distribution and a first spatial distribution.

In some examples, the optical system 410 may include a first optic 435, a second optic 445, a third optic 455, a fourth optic 465, a masking component 470, an optical relay system 475, and a mirror 490. The first optic 435 may be an example of a collimating lens or a mirror, and the first optic 435 may be configured to receive the output of the light source 405 and transmit an output to the second optic 445. In some examples, the output of the first optic 435 may be collimated (e.g., including rays of light that are approximately parallel to each other). In some other examples, the first optic 435 may be configured to virtually image the output of the light source 405 and direct the virtual image to the second optic 445.

The second optic 445 may be an example of an axicon (e.g., a reflective axicon or a refractive axicon) that is configured to receive the output from the first optic 435 (e.g., collimated light) and diverge the collimated light into an annular shape (e.g., a ring). The second optic 445 may transmit light having a second angular distribution and a second spatial distribution, where the second spatial distribution may have the annular shape that is different than a shape of the first spatial distribution. In such cases, the output of the second optic 445 may include light in the annular shape and having the second spatial distribution, a shape of the second angular distribution from the second optic 445 may be the same as a shape of the first angular distribution of the light source 405. In other words, the second optic 445 may modify the light output by the light source 405 and received from the first optic 435 into the annular shape without modifying the shape of the angular distribution of the light emitted by the light source 405.

The third optic 455 and the fourth optic 465 may be configured to focus the light in an annular shape, among other examples, and to modify a diameter of the light output by the third optic 455. For example, and as similarly described with reference to FIGS. 3A and 3B, the third optic 455 may be positioned to focus an output that is in an annular shape and the fourth optic 465 may be configured to modify a diameter of the output of the third optic 455. In such cases, the fourth optic 465 may be positioned between the third optic 455 and the second optic 445 and may be configured to receive the output of the second optic 445 and transmit an output to the third optic 455. Here, the fourth optic 465 may be repositioned to change the magnification of the ring used to cure the adhesive material, thus allowing a same illuminator (e.g., light source 405) to be used for curing multiple adhesive diameters. For example, the fourth optic 465 may be movable or configurable to be located at different distances from the third optic 455. Based on a position of the fourth optic 465 with respect to the third optic 455, the third optic 455 and the fourth optic 465 may function to adjust (e.g., change, modify) a diameter of the light having the annular shape that is output by the third optic 455.

The masking component 470 (e.g., a mask, a masking optic, a component different from an optic) may be positioned between the third optic 455 and the optical relay system 475, and the masking component 470 may be configured to receive the output of the third optic 455. The masking component 470 may be further configured to block a first portion 472-a of the output from the third optic 455, whereas the masking component 470 may enable a second portion 472-b of the output of the third optic 455 to be transmitted. For example, the masking component 470 may be configured to transmit the second portion 472-b having a semi-annular shape (where the first portion 472-a may similarly correspond to a semi-annular shape from the annular light output by the third optic 455). In some examples, the masking component 470 may transmit and block light in different shapes. In any case, the light output by the masking component 470 may have a different shape than the light output by the third optic 455.

The optical relay system 475 may include one or more optical components that may be configured to relay an image of the output of the masking component 470. For example, the optical relay system 475 may include a first lens 480 and a second lens 485. In some cases, the first lens 480 and the second lens 485 may each be examples of aspheric optical components (e.g., aspheric lenses). Here, the first lens 480 may be configured to receive the output from the masking component 470 and transmit an output to the second lens 485. The second lens 485 may receive the output of the first lens 480 and output an image of the output received from the masking component 470. The output of the second lens 485 may be directed to the mirror 490.

The mirror 490 (e.g., a mirror component) may be an example of a fold mirror, among other examples, and the mirror 490 may be configured to direct the output of the optical relay system 475 towards the adhesive material, where an output 492 from the mirror 490 may be incident on the adhesive material and may be used to cure the adhesive material. In some examples, the output 492 from the mirror 490 may include multiple components of light, for example, a first component 497-a (e.g., from a first portion of the mirror 490) and a second component 497-b (e.g., from a second portion of the mirror 490). In such cases, the first component 497-a may be generated by a first system (e.g., including the light source 405 and the optical system 410), whereas the second component 497-b may be based on an output 495 generated by another, similar system (e.g., including another light source and an optical system that may be similar to the optical system 410) and directed to the adhesive material using the mirror 490 (e.g., using another side of the mirror, another portion of the mirror 490) or some other components. In some aspects, the first component 497-a and the second component 497-b may have similar or different properties (e.g., based on a configuration of the respective system used to generate each component). In any case, the configuration of the optical system 410 may enable the modification of the output of the light source 405 to be directed to an adhesive material that is positioned between an optical element and a structural component. Here, the system 400 may redistribute the etendue of the light source 405 into the etendue of the adhesive bond line to enable efficient curing processes for adhesives.

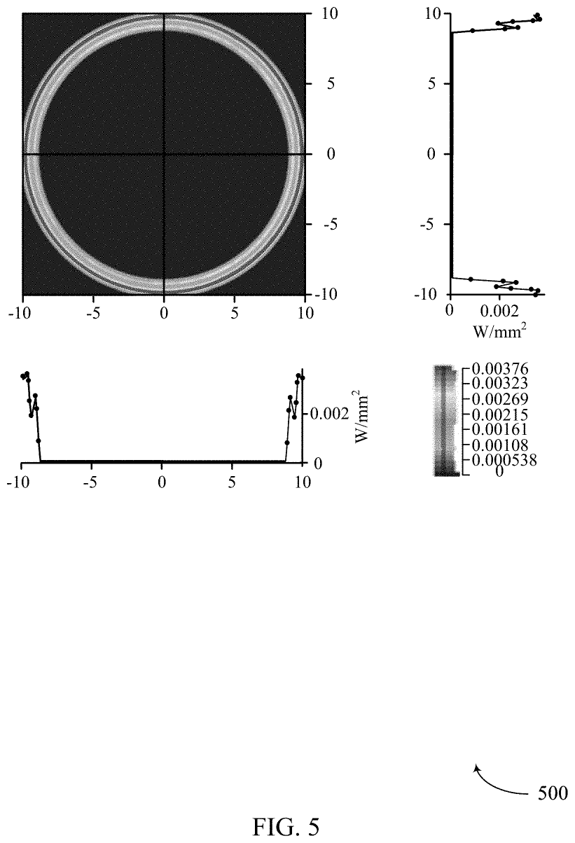

FIG. 5 illustrates an example of an irradiance distribution 500 of a system that supports a method and apparatus for applying light to cure adhesives in accordance with aspects of the present disclosure. As an example, the irradiance distribution 500 may be an example of an irradiance distribution of annular light output by the system 100, the system 200, the system 300, or the system 400, as described with reference to FIGS. 1, 2, 3A, 3B, and 4. As described herein, the output may be used to cure an adhesive material, where the output may include light having an annular shape.

As described herein, a system may be used to transform an output of a light source for curing an adhesive material used to bond an optical element to a structural component. The adhesive material may have an annular shape (e.g., surrounding a circular cylinder lens or other optical component). As such, the light from the light source may be modified to have an annular shape (e.g., a spatial distribution of the light may have an annular shape). As illustrated by the irradiance distribution 500, the energy from the light source may be modified into the annular shape such that the energy from the light source is substantially focused on the adhesive material, enabling efficient curing processes. For example, the radiation from the light source (e.g., a UV light source) may be modified to match the etendue of the adhesive material, which may minimize or limit other components from being exposed to the radiation while limiting a number of light sources used for curing the adhesive.

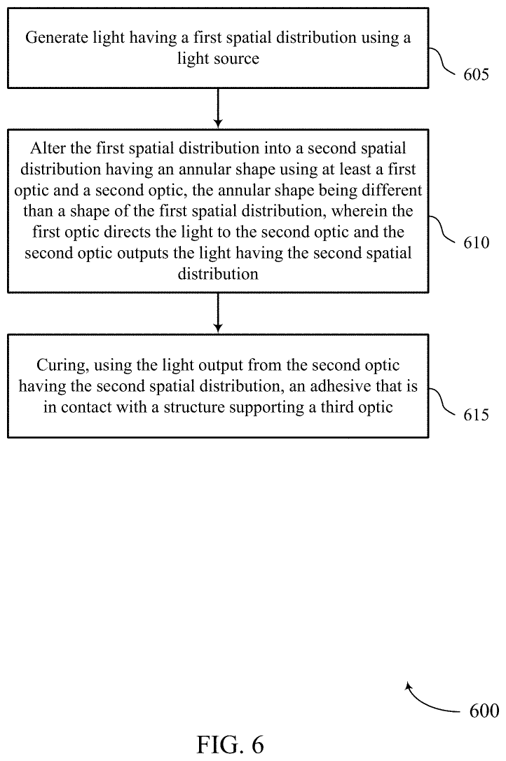

FIG. 6 shows a flowchart illustrating a method 600 that supports applying light to cure adhesives in accordance with aspects of the present disclosure. The operations of the method 600 may be implemented by a device or its components as described herein. For example, the operations of the method 600 may be performed by a system configured for modifying a shape of a spatial distribution of light (e.g., from a UV light source) that is used to cure an adhesive material, as described with reference to FIGS. 1, 2, 3A, 3B, and 4. In some examples, a device may execute a set of instructions to control the functional elements of the device to perform the described functions. Additionally or alternatively, the device may perform aspects of the described functions using special-purpose hardware.

At 605, the method may include generating light having a first spatial distribution using a light source. The operations of 605 may be performed in accordance with examples as disclosed herein.

At 610, the method may include altering the first spatial distribution into a second spatial distribution having an annular shape using at least a first optic and a second optic, the annular shape being different than a shape of the first spatial distribution, where the first optic directs the light to the second optic and the second optic outputs the light having the second spatial distribution. The operations of 610 may be performed in accordance with examples as disclosed herein.

At 615, the method may include curing, using the light output from the second optic having the second spatial distribution, an adhesive that is in contact with a structure supporting a third optic. In embodiments, the third optic is the optical element, as disclosed above. The operations of 615 may be performed in accordance with examples as disclosed herein.

In some examples, an apparatus as described herein may perform a method or methods, such as the method 600. The apparatus may include, features, circuitry, logic, means, or instructions (e.g., a non-transitory computer-readable medium storing instructions executable by a processor) for generating light having a first spatial distribution using a light source, altering the first spatial distribution into a second spatial distribution having an annular shape using at least a first optic and a second optic, the annular shape being different than a shape of the first spatial distribution, where the first optic directs the light to the second optic and the second optic outputs the light having the second spatial distribution, and curing, using the light output from the second optic having the second spatial distribution, an adhesive that is in contact with a structure supporting a third optic (the optical element).

In some examples of the method 600 and the apparatus described herein, the apparatus may include operations, features, circuitry, logic, means, or instructions for aligning the light source relative to the first optic, aligning the second optic relative to a third optic positioned between the second optic and the optical element, and aligning a fourth optic relative to the third optic to focus the light having the annular shape on the adhesive, where aligning at least the third optic and the fourth optic aligns the light having the annular shape with the adhesive.

In some examples of the method 600 and the apparatus described herein, the apparatus may include operations, features, circuitry, logic, means, or instructions for capturing an image of the adhesive while curing the adhesive based on a beamsplitter positioned between the second optic and the third optic, the beamsplitter being optically transmissive to the light output by the second optic.

In some examples of the method 600 and the apparatus described herein, the apparatus may include operations, features, circuitry, logic, means, or instructions for modifying a diameter of the light having the annular shape using the fourth optic, wherein the diameter of the light is based on a distance between the third optic and the fourth optic.

In some examples of the method 600 and the apparatus described herein, the apparatus may include operations, features, circuitry, logic, means, or instructions for forming the light into a second shape different from the annular shape using a masking component that blocks a first portion of the light output by the third optic and outputs a second portion of the light output by the third optic, relaying the light having the second shape using a relay system including one or more optical components, and reflecting the light having the second shape received from the relay system using a mirror component, where curing the adhesive is based on the reflected light being incident on the adhesive using the mirror component.

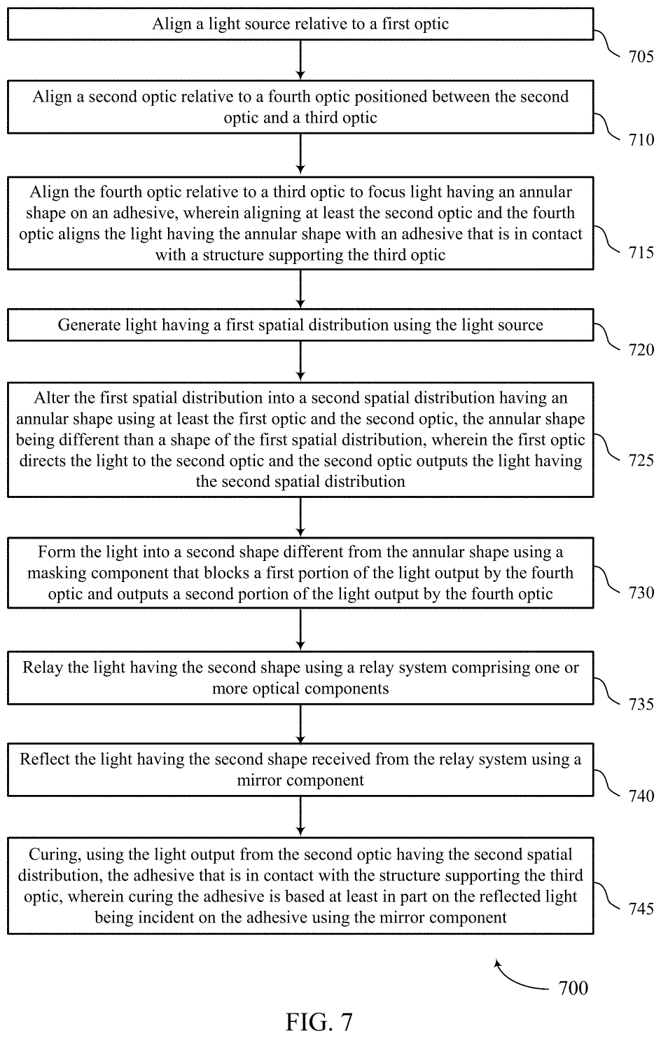

FIG. 7 shows a flowchart illustrating a method 700 that supports applying light to cure adhesives in accordance with aspects of the present disclosure. The operations of the method 700 may be implemented by a device or its components as described herein. For example, the operations of the method 700 may be performed by a system configured for modifying a shape of a spatial distribution of light (e.g., from a UV light source) that is used to cure an adhesive material, as described with reference to FIGS. 1, 2, 3A, 3B, and 4. In some examples, a device may execute a set of instructions to control the functional elements of the device to perform the described functions. Additionally or alternatively, the device may perform aspects of the described functions using special-purpose hardware.

At 705, the method may include aligning a light source relative to a first optic. The operations of 705 may be performed in accordance with examples as disclosed herein.

At 710, the method may include aligning a second optic relative to a fourth optic positioned between the second optic and a third optic. The operations of 710 may be performed in accordance with examples as disclosed herein.

At 715, the method may include aligning the fourth optic relative to a third optic (the optical element) to focus light having an annular shape on an adhesive, where aligning at least the second optic and the fourth optic aligns the light having the annular shape with an adhesive that is in contact with a structure supporting the third optic. The operations of 715 may be performed in accordance with examples as disclosed herein.

At 720, the method may include generating light having a first spatial distribution using the light source. The operations of 720 may be performed in accordance with examples as disclosed herein.

At 725, the method may include altering (e.g., modifying, transforming, changing) the first spatial distribution into a second spatial distribution having an annular shape using at least the first optic and the second optic, the annular shape being different than a shape of the first spatial distribution, were the first optic directs the light to the second optic and the second optic outputs the light having the second spatial distribution. The operations of 725 may be performed in accordance with examples as disclosed herein.

At 730, the method may include forming the light into a second shape (e.g., a semi-annular shape or another shape) different from the annular shape using a masking component that blocks a first portion of the light output by the fourth optic and outputs a second portion of the light output by the fourth optic. The operations of 730 may be performed in accordance with examples as disclosed herein.

At 735, the method may include relaying the light having the second shape using a relay system including one or more optical components. The operations of 735 may be performed in accordance with examples as disclosed herein.

At 740, the method may include reflecting the light having the second shape received from the relay system using a mirror component (e.g., a fold mirror). The operations of 740 may be performed in accordance with examples as disclosed herein.

At 745, the method may include curing, using the light output from the second optic having the second spatial distribution, the adhesive that is in contact with the structure supporting the third optic, where curing the adhesive is based on the reflected light being incident on the adhesive using the mirror component. The operations of 745 may be performed in accordance with examples as disclosed herein.

A system is described. The system may include a light source configured to generate an output having a first spatial distribution. In some examples, the system may include an optical system configured to receive the output of the light source and modify a shape of the first spatial distribution to produce a second spatial distribution having an annular shape that is different than the shape of the first spatial distribution, where the optical system is configured to transmit an output having the annular shape that is incident on an adhesive material to cure the adhesive material.

In some examples of the system, the optical system may include a first optic configured to receive the output of the light source and a second optic configured to receive an output of the first optic and to modify the shape of the first spatial distribution into the annular shape of the second spatial distribution. In some cases, the second optic may be a refractive axicon or a reflective axicon.

In some examples of the system, the optical system may include a third optic configured to receive an output of the second optic and to transmit an output in the annular shape that is focused on the adhesive material, the output of the third optic being incident on the adhesive material to cure the adhesive material. In some cases, the third optic may be a lens, or a mirror, or any combination thereof.

In some examples of the system, the optical system may include a fourth optic positioned between the second optic and the third optic and configured to modify a diameter of the output of the third optic based on a position of the fourth optic with respect to the third optic. In some examples, the third optic may be configured to transmit the output in the annular shape that is telecentric and avoids one or more structures positioned between the third optic and the adhesive material. In some cases, the one or more structures may include a vacuum component that supports an optical component or some other component.

In some examples of the system, the optical system may include a beamsplitter positioned between the second optic and the third optic and configured to receive the output of the second optic and to transmit an output to the third optic, and an optical component (e.g., a camera) configured to capture images, where the beamsplitter may be configured to direct light from the adhesive material to the optical component.

In some examples of the system, the optical system may include a fifth optic configured to receive the output of the second optic, a sixth optic configured to receive an output of the fifth optic and to transmit an output in the annular shape having a diameter that is modified with respect to the output of the fifth optic, and a mask configured to receive the output of the sixth optic, block a first portion of the output of the sixth optic, and transmit a second portion of the output of the sixth optic. In some cases, the optical system may further include an optical relay system configured to receive an output of the mask and to relay an image of the output of the mask and a mirror configured to receive an output of the optical relay system and to modify a direction of the output of the optical relay system toward the adhesive material. In some examples, an output of the mirror includes the light that is incident on the adhesive material and has a shape based on the mask.

In some examples of the system, the output of the light source has a first angular distribution and the output of the optical system has a second angular distribution, and where a shape of the first angular distribution is the same as a shape of the second angular distribution. In some examples of the system, the light source may include a UV light source.

An apparatus is described. The apparatus may include a light source configured to transmit light having a first angular distribution and a first spatial distribution, a collimating lens configured to receive the light transmitted by the light source, and an axicon configured to receive and modify light output by the collimating lens into light having a second angular distribution and a second spatial distribution, where a shape of the second spatial distribution includes an annular shape different than a shape of the first spatial distribution, and where the collimating lens is positioned between the light source and the axicon. In some examples, the apparatus may include a lens configured to focus light having the second spatial distribution output by the axicon onto an adhesive material positioned between a structure and an optical element, where the axicon is positioned between the collimating lens and the lens. In some examples, the apparatus may include the optical element supported by the structure based on the adhesive material that is positioned between the optical element and the structure, where the output of the lens is configured to cure the adhesive material using the focused light from the lens.

In some examples, the apparatus may include a beamsplitter positioned between the axicon and the lens, where the beamsplitter is optically transmissive to the light transmitted by the light source and a camera configured to capture an image of at least a portion of the optical element supported by the structure and the adhesive material, where the beamsplitter is configured to reflect light from the portion of the optical element and the adhesive material to the camera.

In some examples, the apparatus may include a second lens positioned between the axicon and the lens and configured to modify a diameter of light output by the lens based on a distance between the lens and the second lens.

In some examples, the apparatus may include a mask component configured to receive light from the lens and to absorb, or reflect, or both at least a first portion of the light from the lens, where the mask component is configured to transmit an output including a second portion of the light from the lens, one or more aspherical optics configured to receive the output of the mask component and to relay the output of the mask component, and a fold mirror configured to direct an output of the one or more aspherical optics toward the adhesive material to cure the adhesive material.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The various illustrative blocks and modules described in connection with the disclosure herein may be implemented or performed with a general-purpose processor, a digital signal processor (DSP), a central processing unit (CPU), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise random-access memory (RAM), read-only memory (ROM), electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method comprising:
generating light having a first spatial distribution using a light source;
altering the first spatial distribution into a second spatial distribution having an annular shape using at least a first optic and a second optic, the annular shape being different than a shape of the first spatial distribution, wherein the first optic directs the light to the second optic and the second optic outputs the light having the second spatial distribution; and
curing, using the light output from the second optic having the second spatial distribution, an adhesive that is in contact with a structure supporting an optical element.

2. The method of claim 1, further comprising directing the light output from the second optic to a third optic, the third optic focusing the light having the second spatial distribution output by the second optic onto the adhesive.

3. The method of claim 2, wherein the third optic comprises a lens or a mirror.

4. The method of claim 2, modifying a diameter of an output of light from the third optic.

5. The method of claim 4, wherein modifying the diameter of the output of light from the third optic comprises moving a fourth optic relative to the third optic, the fourth optic being positioned between the second optic and the third optic.

6. The method of claim 1, wherein the second optic comprises a refractive axicon or a reflective axicon.

7. The method of claim 1, wherein the optical element is at least one of a lens, a mirror, or a prism.

8. The method of claim 1, wherein curing the adhesive bonds the optical element with the structure.

9. The method of claim 1, wherein the annular shape of the second spatial distribution is at least one of a ring shape, a circular shape, a disk shape, or an ovular shape.

10. The method of claim 1, wherein the second spatial distribution is divergent.

11. The method of claim 1, further comprising directing light from the adhesive to an imaging component.

12. The method of claim 1, further comprising holding the optical element on a chuck while curing the adhesive.

13. The method of claim 12, wherein the light output from the second optic is incident on the adhesive to cure the adhesive but is not incident on the chuck.

14. The method of claim 13, wherein the chuck is a vacuum chuck.

15. The method of claim 1, wherein the adhesive comprises photo-initiators.

16. The method of claim 1, further comprising:
aligning the light source relative to the first optic;
aligning the second optic relative to a third optic positioned between the second optic and the optical element; and
aligning a fourth optic relative to the third optic to focus the light having the annular shape on the adhesive, wherein aligning at least the third optic and the fourth optic aligns the light having the annular shape with the adhesive.

17. The method of claim 16, further comprising:
capturing an image of the adhesive while curing the adhesive using at least a beamsplitter positioned between the second optic and the third optic, the beamsplitter being optically transmissive to the light output by the second optic.

18. The method of claim 16, further comprising:
modifying a diameter of the light having the annular shape using the fourth optic, wherein the diameter of the light is based at least in part on a distance between the third optic and the fourth optic.

19. The method of claim 16, further comprising:
forming the light into a second shape different from the annular shape using a masking component that blocks a first portion of the light output by the third optic and outputs a second portion of the light output by the third optic;
relaying the light having the second shape using a relay system comprising one or more optical components; and
reflecting the light having the second shape received from the relay system using a mirror component, wherein curing the adhesive is based at least in part on the reflected light being incident on the adhesive using the mirror component.

20. The method of claim 1, further comprising blocking a portion of the light output from the second optic.

21. The method of claim 20, wherein the light incident on the adhesive has a different shape than the annular shape of the light output from the second optic.

22. The method of claim 21, wherein the light incident on the adhesive has a semi-annular shape.
